(19) United States
(12) Patent Application Publication
(10) Pub. No.: US 2013/0005564 A1
(43) Pub. Date: Jan. 3, 2013

(54) SYNTHESIS OF CRYSTALLINE LONG-RANGED ORDERED MATERIALS FROM PREFORMED AMORPHOUS SOLIDS

(75) Inventors: RICHARD R. WILLIS, CARY, IL (US); ANNABELLE BENIN, OAK FOREST, IL (US); HUI WANG, DES PLAINES, IL (US); STEPHEN WILSON, LIBERTYVILLE, IL (US)

(73) Assignee: UOP LLC, DES PLAINES, IL (US)

(21) Appl. No.: 13/174,280

(22) Filed: Jun. 30, 2011

(51) Int. Cl. B01J 29/04; B01J 29/18

(52) U.S. Cl. 502/62; 502/60; 502/78

(57) ABSTRACT

Composites of a crystalline or long-ranged ordered material (CLROM), for example zeolites and non-zeolitic molecular sieves, are disclosed. The composites have both a macroscopic particle size (e.g., an average particle size of greater than about 0.1 mm), as desired in commercial applications, as well as improved functionality. Such composites result from the conversion of a conventional amorphous material, for example a solid amorphous silica alumina of this particle size, into the CLROM. According to particular embodiments, all or substantially all (e.g., at least about 99%) of the amorphous material is converted to the CLROM, such that essentially the entire macroscopic material may have the desired functionality of the CLROM as a catalyst or adsorbent.

### FIELD OF THE INVENTION

The present invention relates to the synthesis of a zeolite, a non-zeolitic molecular sieve, or other crystalline or long-ranged ordered material (CLROM) from amorphous solids. Particular aspects of the invention relate to the formation of macroscopic particles comprising a CLROM and having an average particle size of greater than 0.1 mm, from a precursor comprising an amorphous oxide (AO) (e.g., amorphous silica), an amorphous mixed metal oxide (MMO) (e.g., amorphous silica alumina), amorphous aluminum phosphate, or a mixture thereof.

### DESCRIPTION OF RELATED ART

Framework type materials, including zeolites, non-zeolitic molecular sieves, and other crystalline or long-ranged ordered materials (CLROMs) have found numerous commercial applications as catalysts and adsorbents for performing chemical reactions and separations, respectively. The desirable performance characteristics of these materials reside in their uniform crystalline micropore structure. This structure permits molecules having certain molecular dimensions (i.e., size and shape) to readily access the internal micropore environment, having catalytically active components, while excluding other types of molecules. Combined with such shape-selectivity of the framework structure, the framework composition also helps determine the activity and selectivity of a CLROM for catalyzing a given reaction. A significant composition-dependent property, for example, is acidity, which is largely a function of the silica to alumina framework molar ratio in the case of crystalline aluminosilicates. Acidity is highly correlated with catalytic function in many hydrocarbon conversion processes including alkylation, cracking, and isomerization.

Ongoing efforts to develop new CLROMs have focused on the use of various organoammonium templates, also referred to as structure directing agents (SDAs). These are relatively complicated molecules that impart aspects of their structural features to a zeolite or other CLROM to provide a desirable pore structure. See, for example, A. Corma et al., NATURE (2002) 418: 514-517; P. Wagner et al., CHEM. Comm. (1997) 2179-2180; U.S. Pat. No. 5,489,424; and U.S. Pat. No. 6,632,417. Conventional synthesis procedures involve the crystallization of the desired CLROM from a reactive gel or solution containing sources of its metallic components, normally silicon, aluminum, and optionally other metals that ultimately make up the framework of the resulting CLROM. The crystallites that are formed in this manner are typically submicron to several microns in size. However, such CLROM crystallite sizes are generally unacceptable in dynamic (flowing) commercial reaction and separation systems due to their excessive pressure drop characteristics. CLROM crystallite powders, as synthesized, are therefore normally bound into larger agglomerates having macroscopic dimensions, often on the order of 1-2 mm in size (e.g., diameter).

The CLROM binder material, which is usually an amorphous, inorganic refractory metal oxide (e.g., silica, alumina, titania, etc.), unfortunately does not share the desirable catalytic or adsorbent properties of the CLROM and therefore tends to dilute its function. More significantly, however, the binder can slow the transport of molecules into micropores and thereby lead to slow reaction rates and/or the occurrence of unwanted secondary side reactions during the extended residence times of these molecules in the presence of the non-selective reaction sites of the binder material. Such side reactions not only reduce the yield of desired products but also lead to increased coke formation and catalyst deactivation.

Accordingly, there is a need in the art for framework type materials, and particularly aluminosilicates, which offer improved performance, for example in terms of stability and product yield. Such materials desirably minimize the overall, unwanted effects associated with binder materials, for binding CLROMs into agglomerates with a macroscopic particle size, which are used conventionally in the preparation of catalysts and adsorbents.

### SUMMARY OF THE INVENTION

The present invention is associated with the discovery of composites of a crystalline or long-ranged ordered material (CLROM), for example zeolites and non-zeolitic molecular sieves, having both a macroscopic particle size (e.g., an average particle size of greater than about 0.1 mm), as desired in commercial applications, as well as improved functionality. Such composites result from the conversion of a conventional binder material as a precursor, of this particle size, into the CLROM. Representative precursors comprise an amorphous oxide (AO) (e.g., amorphous silica), an amorphous mixed metal oxide (MMO) (e.g., amorphous silica alumina), amorphous aluminum phosphate, and mixtures thereof. In the case of a CLROM comprising or consisting essentially of a zeolite, a suitable precursor is amorphous silica alumina.

According to particular embodiments, when the precursor is amorphous silica alumina that is converted into a zeolite, the SiO₂/Al₂O₃ ratio of the silica alumina is generally at least about 5, typically from about 10 to about 1000, and often from about 10 to about 500. According to other particular embodiments, all or substantially all (e.g., at least about 99%) of the precursor (e.g., amorphous silica alumina) is converted to the CLROM, such that essentially the entire macroscopic material may have the desired functionality of the CLROM as a catalyst or adsorbent. In this manner, the drawbacks associated with using a conventional binder to attain macroscopic particle dimensions, including a reduction in diffusion and an increase in non-selective reactions, are minimized or even eliminated.

The source of solid precursor is in general of the same particle size as desired for the macroscopic particles comprising a CLROM (e.g., a zeolitic material), which results from the conversion or crystallization of this solid source. For example, a macroscopic particle of all or essentially all zeolite having an MFI structure type may be prepared, according to synthesis methods described herein, from the conversion of a conventional binder material, such as an amorphous silica alumina. This starting material or precursor may be obtained as a calcined, oil dropped sphere (ODS), produced according to an oil dropping technique described in greater detail below. Advantageously, oil dropping provides spheres having macroscopic diameters, typically in the range from about 0.3 to 5 mm, with extremely well mixed metal oxides. Overall, ODSs comprising amorphous silica alumina have been found to exhibit unique and beneficial properties, for example, compared to other commercially available silica aluminas, in the application of their conversion to CLROMs and particularly zeolites and non-zeolitic molecular sieves. Beneficially, when ODSs of the starting material or precursor are subjected to CLROM preparation conditions, including aging, digestion, solid-liquid separation, and optionally any post synthesis treatment, the desired crystalline phases are obtained, typically with the maintenance of macroscopic sphere integrity. Alternatively, the solid source of amorphous silica alumina or other precursor may be obtained as an extruded material (i.e., an extrudate) having a cylindrical form, or as any other macroscopic shape prepared via forming, bonding and/or compositing.

Embodiments of the invention are therefore directed to macroscopic particles comprising CLROMs, including macroscopic zeolitic materials and macroscopic non-zeolitic molecular sieve materials, having an average particle size of greater than 0.1 mm and comprising at least about 90% by weight, and often at least about 99% by weight, CLROM (e.g., zeolite or non-zeolitic molecular sieve), wherein the CLROM is crystallized from a precursor, and preferably a solid source of an amorphous oxide (AO) and/or an amorphous mixed metal oxide (MMO). Representative AOs and MMOs include, for example, amorphous silica and amorphous silica alumina. Another type of precursor is an amorphous aluminum phosphate.

Amorphous silica alumina is a preferred precursor, in the case of forming a zeolite as a CLROM. Generally, the source of amorphous silica alumina or other type of precursor mentioned above is of approximately the same size as the resulting macroscopic particles comprising a CLROM. In the case of a sphere or an extrudate (having a cylindrical form and a diameter that is the diameter of a circular cross-section), the macroscopic particle comprising a CLROM generally has a diameter within about 3% of the diameter of the amorphous silica alumina. More specific embodiments of the invention are directed to macroscopic particles comprising CLROMs, including macroscopic zeolitic materials and macroscopic non-zeolitic molecular sieve materials, having an average particle size of greater than 0.1 mm and consisting essentially of CLROM (e.g., zeolite or non-zeolitic molecular sieve), wherein the CLROM is crystallized from a solid source of amorphous silica alumina (e.g., amorphous silica alumina phosphate) or other solid source of a precursor comprising an AO, another type of MMO, an amorphous aluminum phosphate, or a mixture thereof.

Other embodiments of the invention are directed to methods for preparing a macroscopic particle comprising a CLROM (e.g., a macroscopic zeolitic material or a macroscopic non-zeolitic molecular sieve). Representative methods comprise contacting a solid source of amorphous silica alumina or other precursor with a structure directing agent (SDA) such as an aqueous solution of an organoammonium hydroxide and subjecting the precursor to CLROM forming conditions (e.g., zeolite forming conditions or non-zeolitic molecular sieve forming conditions) to crystallize a CLROM (e.g., a zeolite or a non-zeolitic molecular sieve) from at least a portion of the solid source or precursor and provide the macroscopic particle comprising a CLROM. Such macroscopic particles generally have a particle size of greater than about 0.1 mm. The CLROM forming conditions used normally encompass both mixing/aging and digestion conditions, each of which are characterized by a temperature or temperature range at which the solid source of amorphous silica alumina and SDA are maintained, as well as a time over which this temperature or temperature range is maintained. Elevated pressures may accompany either or both of the mixing/aging and digestion, and preferably accompany the latter.

As discussed in greater detail below, in the case of forming a CLROM comprising or consisting essentially of a zeolite, there are several possibilities for carrying out the contacting between a precursor, and preferably a solid source of amorphous silica alumina, and the SDA to crystallize at least a portion of the solid source into the desired CLROM. For example, direct contact between the precursor and an aqueous or non-aqueous solution of the SDA may be used. Representative non-aqueous solvents for SDAs, which can beneficially reduce the dissolution of silica in the solid source, include polyols such as glycerol. The contacting may be followed by the removal of excess aqueous or non-aqueous solvent, through the application of heat, vacuum pressure, or a combination thereof, to provide an SDA-impregnated precursor, for example an SDA-impregnated amorphous silica alumina. The contacting may precede the exposure of the amorphous silica alumina or other precursor to zeolite forming conditions, or otherwise the contacting may be performed under such conditions, for example in the case of vapor phase transport (VPT) contacting as described below.

Direct contacting methods include further contact between the precursor and SDA and a crystallization inducing templating agent in controlled amounts, to better match the charge density between the precursor and SDA reactant mixture, leading to crystallization as described in U.S. Pat. No. 7,578,993. Such charge density matching techniques are particularly applicable to the formation of high silica to alumina framework molar ratio (SiO₂/Al₂O₃ ratio) zeolites, including those having the MFI structure type with an SiO₂/Al₂O₃ ratio of at least about 30. Direct contacting methods may also be accompanied by steam (i.e., to provide steam assisted crystallization). Steam assisted crystallization may be achieved, for example, by initially contacting the precursor and a solution of the SDA, in either an aqueous or non-aqueous solvent, to provide an SDA-impregnated precursor such as SDA-impregnated amorphous silica alumina. This is followed by contacting the SDA-impregnated precursor with steam to form the macroscopic particle comprising a CLROM (e.g., macroscopic zeolitic material). According to a representative embodiment, the SDA-impregnated precursor is maintained separate from, namely above, a water or aqueous solution level, and the water or aqueous solution is boiled to generate steam that contacts the SDA-impregnated precursor and assists in its crystallization.

According to further specific embodiments involving vapor phase transport (VPT), the solid source of amorphous silica alumina or other precursor is contacted with vapors of the SDA. In this case, the SDA is generally a volatile component, and is preferably, for example, an amine, diamine, or alkanolamine corresponding to the quaternary organoammonium, diquaternary organoammonium, and quaternary alkanolammonium compounds, respectively, useful as SDAs in aqueous solution form.

These and other embodiments and aspects relating to the present invention are apparent from the following Detailed Description.

### BRIEF DESCRIPTION OF THE DRAWINGS

FIG. 1 is a scanning electron microscope (SEM) image of an oil dropped sphere (ODS) that provides a representative solid source of amorphous silica alumina.

FIGS. 2-4 are SEM images of a macroscopic zeolitic material, crystallized from ODSs of the type shown in FIG. 1, following contact with vapors obtained from a mixture of ethylene diamine (EDA) and tetraethylamine (TEA) at 175° C. (347° F.) for 5 days (FIG. 2), 6 days (FIGS. 3), and 7 days (FIG. 4).

FIGS. 5-7 are X-ray diffraction patterns of zeolites formed from subjecting ODSs to various zeolite forming conditions, including direct contact with an aqueous solution of a structure directing agent (SDA) (FIG. 5), contact with a non-aqueous solution of an SDA (FIG. 6), and contact with vapors of an SDA (FIG. 6).

### DETAILED DESCRIPTION

### Solid Source of Amorphous Silica Alumina

Various solid sources of amorphous silica alumina or other precursors, as described above, may be crystallized according to the methods described herein to provide a macroscopic particle comprising a crystalline or long-ranged ordered material (CLROM), such as a macroscopic zeolitic material, having approximately the same dimensions as the solid source prior to crystallization. In the case of zeolites as CLROMs, amorphous silica alumina sources are preferred, and these sources are characterized in that they contain both silica and alumina at a molar ratio that leads to the formation of a CLROM with desirable properties in terms of its framework SiO₂/Al₂O₃ molar ratio (SiO₂/Al₂O₃ ratio) for a given structure type (which defines the nature of its micropores). In representative embodiments, the amorphous silica alumina precursor or starting material has a SiO₂/Al₂O₃ molar ratio of at least about 5 (i.e., from about 5 to infinity, with the upper bound corresponding to amorphous silica). According to other embodiments, the amorphous silica alumina has a SiO₂/Al₂O₃ ratio typically from about 10 to about 1000, and often from about 10 to about 500.

Representative solid sources of AOs or MMOs, in addition to metal oxides, may also contain other forms of metals that may be incorporated into the framework of the resulting CLROM. These solid sources comprises generally at least about 80%, typically at least about 90%, and often at least about 95%, of amorphous metal oxides by weight. Solid sources of amorphous silica alumina, for example, comprise generally at least about 80%, typically at least about 90%, and often at least about 95%, of amorphous silica and amorphous alumina by weight. The balance may be due to contributions from other metal oxides (e.g., titania) and/or other components of the desired CLROM (e.g., additional metals such as Fe or Mg), metals that provide ion exchangeable sites (e.g., Na, K, or Li), and/or crystalline components (e.g., crystalline silica or crystalline alumina). In some cases, phosphate may be included in amorphous silica alumina, and the term amorphous silica alumina is therefore understood to also embrace amorphous silica alumina phosphates. Normally, the solid source of amorphous silica alumina is completely amorphous, but it is possible that this source may also contain crystalline materials, generally in an amount of less than about 10% by weight, and often less than about 1% by weight. In the case of an oil dropped sphere, for example, the presence of a crystalline material may result from its incorporation (e.g., as a zeolite suspension) into a silica or alumina sol used to form the sphere. Representative solid sources of amorphous aluminum phosphate comprise this compound in an amount, by weight, of generally at least about 80%, typically at least about 90%, and often at least about 95%

As discussed above, an oil dropped sphere (ODS) represents a preferred source of an amorphous silica alumina or other precursor, due to the thorough and intimate mixing of silica and alumina, and/or other components of the precursor, resulting from the oil dropping process. Relative to other solid sources of silica alumina, for example, ODSs have been found to promote good formation of crystalline phases upon subjecting the spheres to CLROM forming conditions in the presence of a structure directing agent (SDA), with good maintenance of macroscopic sphere integrity. Oil dropping generally refers to a process in which acidified sources of silica and alumina, and/or other components of the precursor, are combined with a neutralization/gelling agent and formed into droplets that fall through a vertical column of hot oil for a time sufficient to harden or set the gel. The amorphous silica alumina or other precursor, used as a solid source described herein, is normally obtained following aging, washing, drying, and calcining of the formed spheres after they exit the oil-filled dropping tower.

According to a representative process for forming oil dropped spheres as solid sources of amorphous silica alumina, an alumina sol is prepared by digesting aluminum pellets or gibbsite in an HCl solution, and a separate silica sol is obtained by reacting a sodium silicate solution (“waterglass”) with HCl for acidification. A crystalline material, for example in the form of a zeolite suspension, may be added to the alumina sol or silica sol, in order to impart a minor amount of crystallinity to the resulting ODS. A neutralization/gelling agent, generally a weak base such as ammonia and/or urea, or otherwise hexamethyltetraamine (HMT), is added to the sols either individually or in combination. The sols are mixed and the aqueous mixture containing the neutralization/gelling agent is fed to the top of a forming tower filled with circulating hot oil, typically at a temperature from about 90° C. (194° F.) to about 110° C. (230° F.). Upon contact between the aqueous mixture and oil, which are immiscible phases, silica alumina spheres are formed as macrospherical droplets dispersed into the oil. These spheres fall to the bottom of the forming tower and are transported to an aging tank, also filled with hot oil, typically at a somewhat higher temperature from about 100° C. (212° F.) to about 120° C. (248° F.). At the elevated temperatures in the forming tower and aging tank, the neutralization/gelling agent is decomposed, and the liberation of ammonia from this decomposition helps to set the gel. Aging may be performed at atmospheric or elevated pressure, with increasing pressures directionally requiring higher aging temperatures and shorter aging times to provide spheres with good mechanical integrity.

After aging in hot oil, the formed spheres may be further aged in aqueous ammonia solution, to acquire desired physical and mechanical properties. When aging is completed, the formed spheres are washed with an aqueous solution of ammonium nitrate to help remove ammonium chloride and sodium ions from the silica alumina gel. The washed spheres are transferred first to a drying step and then to a calcination step, with typical temperatures of these steps being about 135° C. (275° F.) and 600° C. (1112° F.), respectively. The drying serves to remove residual water, while calcination removes residual oil and sets the internal pore structure of the amorphous silica alumina. Representative sources of amorphous silica alumina are therefore calcined, oil dropped spheres having undergone the sol formation, oil dropping, aging, drying, and calcination steps described above.

### Formation of the CLROM

As discussed above, the CLROM is advantageously formed as a macroscopic material, by crystallization of all or a portion of the solid source of amorphous silica alumina or other precursor (e.g., amorphous aluminum phosphate) as described above. This formation involves contacting the solid source with an SDA as an aqueous solution, a non-aqueous solution, or a vapor. When used as a solution, representative SDAs include organoammonium compounds, generally having a quaternary organoammonium ion, a diquaternary organoammonium ion, or a quaternary alkanolammonium ion, and particularly compounds that are the hydroxide and halide salts of these ions. Useful SDAs therefore include trialkylammonium salts such as trialkylammonium hydroxide (e.g., tripropylammonium hydroxide); tetraalkylammonium hydroxide (e.g., tetrapropylammonium hydroxide or tetraethylammonium hydroxide); trialkylammonium chloride, bromide, or iodide; or tetraalkylammonium chloride, bromide, or iodide. More generally, the SDA may be selected from a number of possible compounds having an organic cation, which instead of a quaternary organoammonium ion, may alternatively be a diquaternary organoammonium ion or a quaternary alkanolammonium ion. Other SDAs include protonated amines and protonated alkanolamines and their non-protonated forms. Non-limiting examples of quaternary ammonium ions are tetramethyl-, ethyltrimethyl-, methyltriethyl, diethyldimethyl-, trimethylbutyl-, and trimethylpropyl-ammonium ions. Non-limiting examples of diquaternary ammonium ions are hexamethonium, pentamethonium, octamethonium, decamethonium, dimethylene bis(trimethylammonium), trimethylene bis(trimethylammonium), methylene bis(trimethylammonium) and tetramethylene bis(trimethylammonium). Non-limiting examples of non-protonated amines and non-protonated alkanolamines are propylamine, butylamine, triethylamine, tri-propylamine and diethanolamine.

Contact between the precursor (e.g., solid source of amorphous silica alumina) and the SDA in solution form (either aqueous or non-aqueous) may involve contacting with an excess of the SDA, beyond the amount needed to penetrate the pores and wet the surface of the solid source. Otherwise, the amount of SDA may be limited to that needed to impregnate the solid source, with excess solvent from the SDA solution being removed through heating, the use of vacuum pressure, or a combination thereof. Contacting between the solid source and SDA in this case provides an SDA-impregnated amorphous silica alumina. Impregnation with SDA solution is often preferred, for example, in the case of aqueous solutions in which excess water can lead to the dissolution of silica present in the solid source, even though such dissolution does not necessarily preclude the dissolved silica from crystallizing to form the CLROM under suitable forming conditions.

The contacting between the solid source and SDA may, according to other embodiments, result in a reaction mixture that is incapable of crystallization due to a charge density mismatch between the solid source and SDA, particularly in the case of forming CLROMs having a high silica to alumina framework molar ratio (SiO₂/Al₂O₃ ratio), including zeolites having the MFI structure type. In this case, it is possible to further contact the solid source and SDA with a crystallization inducing template (or charge density mismatch (CDM) solution) comprising a second organic cation that is different from the organic cation of the SDA. The controlled addition of such a second cation can be used to overcome the effect of the charge density mismatch and allow crystallization of the CLROM (e.g., zeolite) to proceed. Representative second organic cations include the same cations as discussed above with respect to the SDA and therefore encompass quaternary organoammonium ions, diquaternary organoammonium ions, quaternary alkanolammonium ions, protonated amines, and protonated alkanolamines. Other representative crystallization inducing templates include alkali metal cations and alkaline earth metal cations. Combinations of such organic cations and metal cations may also be used in a CDM solution.

According to further embodiments involving the direct contact between the solid source of amorphous silica alumina and an aqueous or non-aqueous solution of the SDA, the crystallization necessary to form the macroscopic material comprising the CLROM is assisted by the use of steam. In this case, the solid source and SDA (e.g., as an SDA-impregnated amorphous silica alumina as described above) are contacted with steam to provide the macroscopic material (e.g., macroscopic zeolitic material).

When the solid source is contacted with the SDA in the vapor phase, a volatile form of the SDA is generally preferred, and representative volatile forms are normally the organoamines corresponding to these organoammonium compounds useful as SDAs in solution (e.g., as an aqueous solution). Representative SDAs therefore include amines (e.g., trialkylamines such as tripropylamine or tetralkylamines such as tetraethylamine), diamines (e.g., ethylenediamine), and alkanolamines (e.g., ethanolamine). Heating of the volatile SDA therefore generates the necessary vapors for contacting with the solid source, according to particular embodiments involving vapor phase transport contacting.

Regardless of the particular contacting between the solid source and SDA, which may involve direct contact with an aqueous solution (possibly in addition to a crystallization inducing template or possibly with the assistance of steam), contact with a non-aqueous solvent (e.g., a polyol such as glycerol), or vapor phase transport, the amorphous silica alumina and the SDA must be subjected to CLROM forming conditions to crystallize the CLROM from at least a portion of the solid source and provide the macroscopic particle comprising a CLROM. Representative forming conditions are generally sufficient to carry out the necessary aging and digestion for crystallization of the desired amount of the solid source of amorphous silica alumina. Forming conditions generally include a contacting temperature from about 20° C. (68° F.) to about 300° C. (572° F.) a contacting time from about 5 hours to about 15 days, and a contacting pressure from ambient pressure to about 2.1 MPa (300 psig). The forming conditions may be held constant over the duration of the contacting time, but generally these conditions vary and may be separated, for example, into an aging step at a first temperature and pressure (or ranges of first temperatures and pressures), followed by a digestion step at a second temperature and pressure (or ranges of second temperatures and pressures). Suitable aging conditions generally include a temperature from about 20° C. (68° F.) to about 100° C. (212° F.) a time from about 0 to about 24 hours, and ambient pressure. Suitable digestion conditions generally include a temperature from about 60° C. (140° F.) to about 200° C. (212° F.) a time from about 8 hours to about 10 days, and a pressure from ambient pressure to about 2.1 MPa (300 psig).

Following formation of the macroscopic material, various post-synthesis treatments may be performed, including ion exchange with one or more catalytic constituents (e.g., ions of catalytically active metals), in addition to adjustment of the charge of these ions by oxidation or reduction to impart the desired catalytic activity. Leeching with an acid or base to adjust surface properties, calcination to remove residual templating agents, and various other post-synthesis and forming steps may also be performed.

### Properties of the CLROM

The macroscopic material, which is synthesized from a solid source of silica alumina or other precursor as described herein, advantageously comprises a CLROM (e.g., a zeolite) as a macroscopic material, having a particle size and shape that is essentially the same as that of the starting solid source. The macroscopic material can therefore generally have a particle size of greater than 0.1 mm, which is considerably greater than conventionally-prepared, separate crystallites of CLROM. As discussed above, such crystallites are conventionally bound into macroscopic particles with a binder that does not provide the same performance, in catalytic reactions and adsorptive separations, as the CLROM, and thereby reduces its efficiency. Typically, the macroscopic material comprising a CLROM has an average particle size from about 0.3 mm to about 5 mm, which is representative of catalyst particle dimensions for use in fixed bed applications, under flowing conditions, which do not promote excessive pressure drop.

It is possible to convert essentially all of the solid source to a CLROM such as a zeolite, thereby providing this material in essentially pure form. Otherwise, incomplete crystallization may be desirable in some cases to improve the mechanical integrity of the macroscopic material. Those skilled in the art, with the knowledge gained from the present specification, will appreciate the tradeoff between strength and performance, in optimizing the macroscopic material for a given application. In general, any uncrystallized portion, when present, will represent only a minor quantity of the material. For example, this portion is generally present in an amount of less than about 10% by weight, typically less than about 5% by weight, and often less than about 1% by weight.

Depending on the particular composition (e.g., the silica to alumina molar ratio) of the solid source (e.g., an AO, a MMO, and/or aluminum phosphate) and the SDA, a wide variety of CLROMs may be synthesized and contained in the macroscopic material as described herein, optionally with a minor uncrystallized portion of the solid source. Such CLROMs include both zeolites and non-zeolitic molecular sieves. Representative zeolites include those having structure types selected from the group consisting of MFI, MOR, BEA, and MWW. These structure types are described, and further references are provided, in Meier, W. M, et al., Atlas of Zeolite Structure Types, 4^{th} Ed., Elsevier: Boston (1996). Beta zeolite, having structure type BEA, is described, for example, in U.S. Pat. No. 3,308,069 and Re No. 28,341, which are incorporated herein with respect to their description of this material. Specific examples of MFI zeolites are ZSM-5 and silicalite. Zeolites may be formed according to the methods described herein with a relatively high SiO₂/Al₂O₃ molar ratio, for example at least about 30 (e.g., in the range from about 50 to about 150), particularly in the case of zeolites having an MFI structure type.

A non-zeolitic molecular sieve (NZMS) may also be formed as CLROMs from the precursor, including a solid amorphous silica alumina, such as an amorphous silica alumina phosphate, or from an amorphous aluminum phosphate. Non-zeolitic molecular sieves include ELAPO molecular sieves which have the proper level of acidity and are embraced by an empirical chemical composition, on an anhydrous basis, expressed by the formula:

(ELₓAl_{y}P_{z})O₂

where EL is an element selected from the group consisting of silicon, magnesium, zinc, iron, cobalt, nickel, manganese, chromium and mixtures thereof, x is the mole fraction of EL and is often at least 0.005, y is the mole fraction of aluminum and is at least 0.01, z is the mole fraction of phosphorous and is at least 0.01 and x+y+z=1. When EL is a mixture of metals, x represents the total amount of the element mixture present. The preparation of various ELAPO molecular sieves are well known in the art and may be found in U.S. Pat. No. 5,191,141 (ELAPO); U.S. Pat. No. 4,554,143 (FeAPO); U.S. Pat. No. 4,440,871 (SAPO); U.S. Pat. No. 4,853,197 (MAPO, MnAPO, ZnAPO, CoAPO); U.S. Pat. No. 4,793,984 (CAPD); U.S. Pat. No. 4,752,651 and U.S. Pat. No. 4,310,440; all of which are incorporated by reference. Representative ELAPO molecular sieves include ALPO and SAPO molecular sieves.

The zeolite or NZMS formed according to the synthesis methods described herein are normally observed as crystallites that are grown from the amorphous macroscopic starting material (or precursor) and present in the macroscopic material. The average crystallite size may be determined from Scanning Electron Microscopy (SEM) analysis. In general, the zeolites or non-zeolitic molecular sieves formed according to the methods and present in the macroscopic materials, as described herein, advantageously have an average crystallite size of generally less than about 10 microns (μm) (e.g., from about 0.3 μm to about 10 μm), and typically less than about 5 μm (e.g., from about 0.5 μm to about 5 μm). These small crystallite sizes provide good diffusion characteristics in the resulting macroscopic material.

Overall, aspects of the invention are directed to macroscopic materials comprising relatively large amounts (e.g., at least about 90% by weight) of CLROMs, formed from crystallization of amorphous silica aluminas (including amorphous silica alumina phosphates), AOs, other MMOs, and/or aluminum phosphates of approximately the same dimensions, for example oil dropped spheres. A particular aspect of the invention relates to a macroscopic zeolitic material having an average particle size of greater than 0.1 mm and consisting essentially of zeolite that is crystallized from a solid source of amorphous silica alumina. Another aspect of the invention relates to a macroscopic material having an average particle size of greater than 0.1 mm and comprising at least about 90% of a crystalline or long-ranged ordered material (CLROM), wherein the CLROM is crystallized from a precursor comprising amorphous silica alumina phosphate, an amorphous oxide (AO), amorphous aluminum phosphate, or a mixture thereof

Further aspects of the invention are directed to various methods of preparing these macroscopic materials, including direct contacting with aqueous and non-aqueous solutions of an SDA (and optionally a crystallization inducing template or steam), or contacting with vapors of an SDA. Those having skill in the art, with the knowledge gained from the present disclosure, will recognize that various changes could be made in these materials and synthesis methods without departing from the scope of the present invention. Mechanisms used to explain theoretical or observed phenomena or results, shall be interpreted as illustrative only and not limiting in any way the scope of the appended claims.

The following examples are set forth as representative of the present invention. These examples are not to be construed as limiting the scope of the invention as other equivalent embodiments will be apparent in view of the present disclosure and appended claims.

### EXAMPLES 1-37

Macroscopic zeolitic materials were prepared by contacting calcined, oil dropped spheres (ODSs) of amorphous silica alumina (approx. 2 mm in diameter) with a structure directing agent (SDA) according to the zeolite forming methods described above. Each of Examples 1-37 involved the use of a different ODS starting material, made during different oil dropping runs with varying compositions (e.g., silica and alumina sol ratios) and oil dropping conditions, as described above. In each case, however, the ODS starting material was a calcined, amorphous silica alumina.

The zeolite forming methods, used to crystallize at least a portion of the ODS, could be classified among the following synthesis techniques: (i) direct contact between the ODS and an aqueous solution of tetrapropylammonium hydroxide (TPAOH) as the SDA, demonstrated in Examples 1-8; (ii) contact between the ODS and a non-aqueous solution of TPAOH as the SDA and glycerol as the solvent, as demonstrated in Examples 9-24; and (iii) contact between the ODS and vapors of the SDA (i.e., vapor phase transport), as demonstrated in Examples 25-37. These vapors were obtained upon heating an aqueous solution of ethylene diamine (EDA) and triethyl amine (TEA), as the SDA, in Examples 25-27 and 32-37, or otherwise heating an aqueous solution of EDA only, in Examples 28-31. In Examples 5-8, employing technique (i), the ODS and SDA were further contacted with a crystallization inducing templating agent, or charge density mismatch (CDM) solution, as described above, to promote crystallization of the zeolite. Examples 6 and 8 incorporated sodium ions into the CDM, as NaCl. In Examples 9-24, employing technique (ii), the ODS was first impregnated with the solution of SDA and non-aqueous solvent, and excess solvent was driven off under vacuum conditions, prior to subjecting the resulting SDA-impregnated amorphous silica alumina (i.e., the SDA-impregnated ODS) to the zeolite forming conditions.

Table 1 below summarizes the experiments corresponding to Examples 1-37, including (a) the type of ODS/TPA contacting used, according to either method (i), (ii), or (iii) above, and (b) the zeolite-forming conditions used, in terms of the time and temperature of the ODS/TPA contacting for crystallizing a zeolite from the ODS.

TABLE 1
Summary of Experiments-Crystallization of Amorphous ODSs

| | | Temperature, | |
|---|---|---|---|
| Examples | SDA Contacting Method | ° C. | Time, Days |
| 1-4 | Direct contact/aqueous | 150 | 1 |
| | solution | | |
| 5 | Direct contact/aqueous | 150 | 6 |
| | solution + CDM solution | | |
| 6 | Direct contact/aqueous | 150 | 6 |
| | solution + CDM (NaCl) | | |
| 7 | Direct contact/aqueous | 150 | 6 |
| | solution + CDM solution | | |
| 8 | Direct contact/aqueous | 150 | 6 |
| | solution + CDM (NaCl) | | |
| 9-12 | Non-aqueous solution | 175 | 7 |
| 13 | Non-aqueous solution | 150 | 7 |
| 14 | Non-aqueous solution | 150 | 7 |
| 15 | Non-aqueous solution | 150 | 5 |
| 16-18 | Non-aqueous solution | 175 | 5 |
| 19 | Non-aqueous solution | 175 | 7 |
| 20 | Non-aqueous solution | 175 | 10 |
| 21 | Non-aqueous solution | 175 | 7 |
| 22 | Non-aqueous solution | 175 | 5 |
| 23 | Non-aqueous solution | 175 | 7 |
| 24 | Non-aqueous solution | 175 | 10 |
| 25-26 | Vapor phase transport | 175 | 7 |
| 27 | Vapor phase transport | 175 | 5 |
| 28-31 | Vapor phase transport | 175 | 7 |
| 32, 35 | Vapor phase transport | 175 | 5 |
| 33, 36 | Vapor phase transport | 175 | 6 |
| 34, 37 | Vapor phase transport | 175 | 7 |

The experiments summarized above therefore involved crystallization of at least a portion of the ODS to provide, in each of Examples 1-37, macroscopic zeolitic materials of approximately the same size as the starting, amorphous silica alumina. These zeolitic materials formed in each case had an MFI structure type with SiO₂/Al₂O₃ ratios ranging from 76-110. The zeolitic materials consisted essentially of crystallites of the formed zeolite.

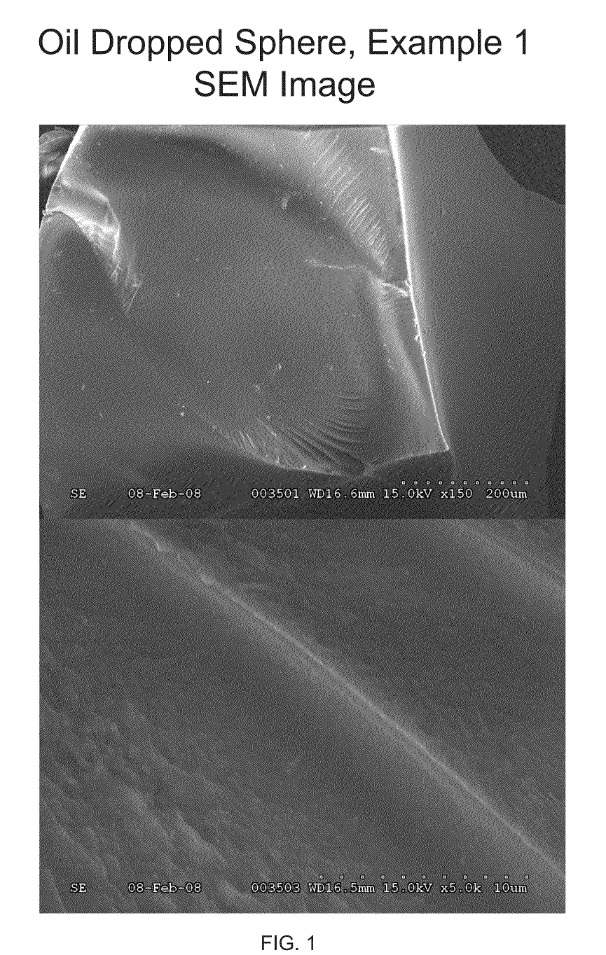

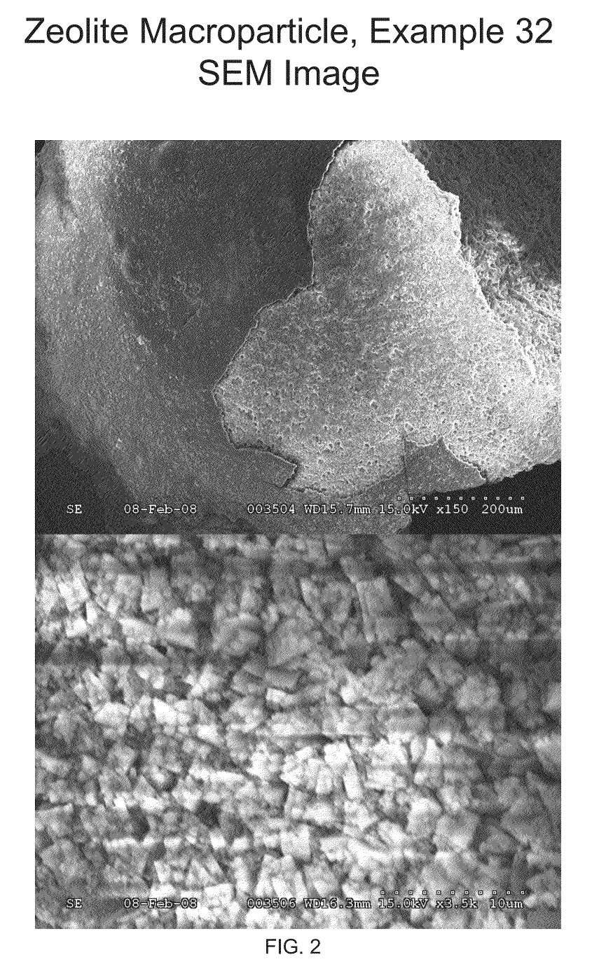

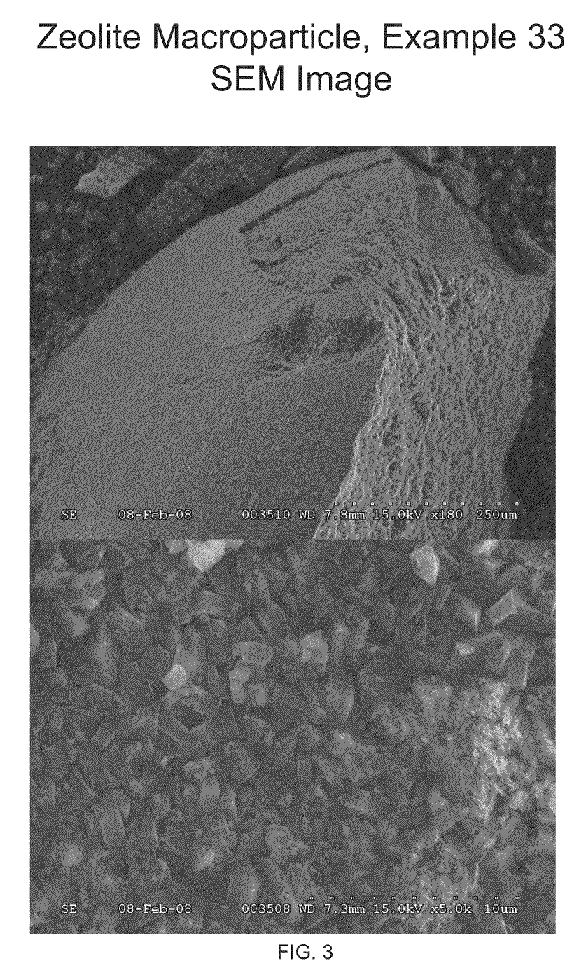

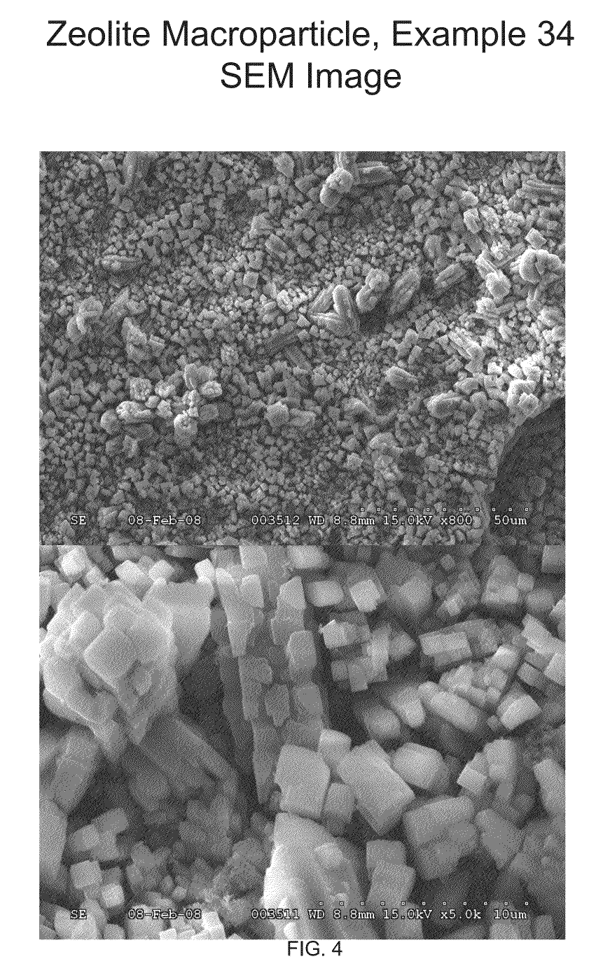

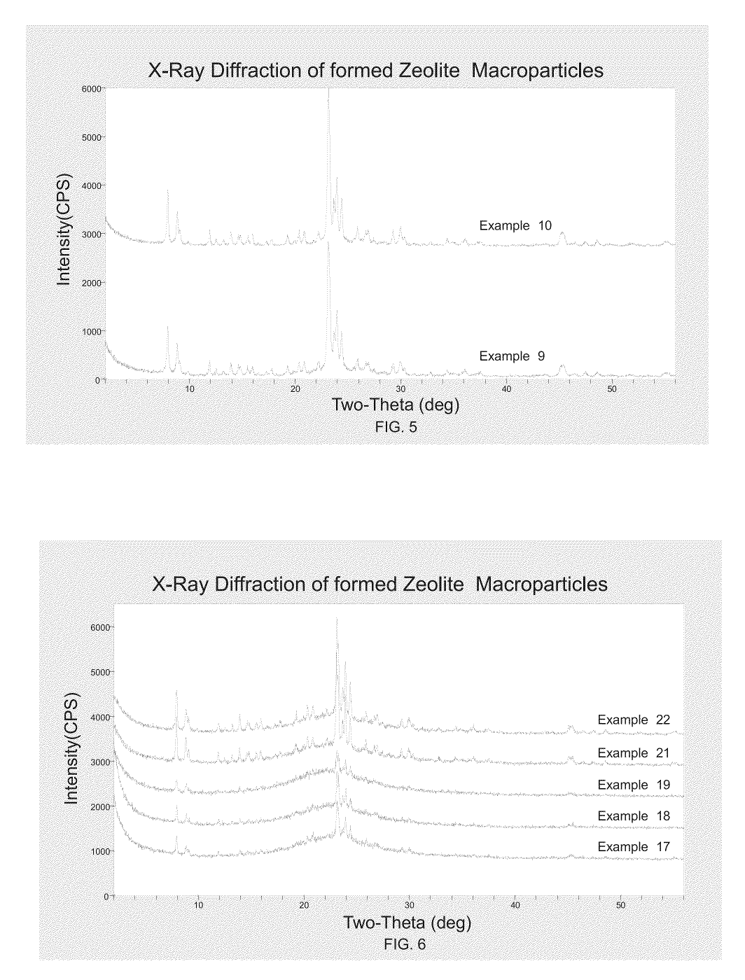

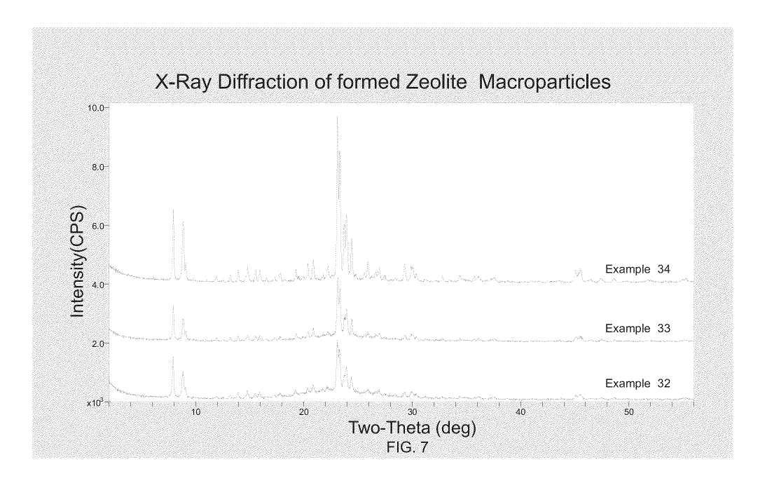

The non-crystalline (amorphous) nature of the ODS starting materials is illustrated in the scanning electron microscope (SEM) image of FIG. 1, showing the surface of the ODS used in Example 1 in particular. In contrast, the SEM images in FIGS. 2-4 show clearly the formation of crystallites of the zeolitic macroparticles prepared in Examples 32-34, respectively, after subjecting the ODS and SDA to zeolite forming conditions as described above. The X-ray diffraction patterns exhibited by the macroscopic zeolitic materials were characteristic of MFI structure type zeolites, as shown in (i) FIG. 5 for the materials prepared in Examples 9 and 10, using direct contact with an aqueous solution of the SDA, (ii) FIG. 6 for the materials prepared in Examples 17-19, 21, and 22, using contact with a non-aqueous (glycerol) solution of the SDA, and (iii) FIG. 7 for the materials prepared in Examples 32-34, using vapor phase transport for contacting with vapors of the SDA.

1. A macroscopic material having an average particle size of greater than 0.1 mm and comprising at least about 90% of a crystalline or long-ranged ordered material (CLROM), wherein the CLROM is crystallized from a solid source of amorphous silica alumina having an SiO₂/Al₂O₃ molar ratio of at least about 5.

2. The macroscopic material of claim 1, wherein the CLROM is a zeolite.

3. The macroscopic material of claim 2, wherein the zeolite has a structure type selected from the group consisting of MFI, MOR, BEA, and MWW.

4. The macroscopic material of claim 3, wherein the zeolite has an MFI structure type and a SiO₂/Al₂O₃ ratio of at least about 30.

5. The macroscopic material of claim 1, wherein the average particle size is from about 0.3 mm to about 5 mm.

6. The macroscopic material of claim 1, further comprising an uncrystallized portion of the solid source of amorphous silica alumina.

7. The macroscopic material of claim 6, wherein the uncrystallized portion is present in an amount of less than about 10% by weight.

8. A macroscopic material having an average particle size of greater than 0.1 mm and comprising at least about 90% of a crystalline or long-ranged ordered material (CLROM), wherein the CLROM is crystallized from a precursor comprising amorphous silica alumina phosphate, an amorphous oxide (AO), amorphous aluminum phosphate, or a mixture thereof

9. A method for preparing a macroscopic zeolitic material, the method comprising:
(a) contacting a solid source of amorphous silica alumina with a structure directing agent (SDA), and
(b) subjecting the amorphous silica alumina and the SDA to zeolite forming conditions to crystallize a zeolite from at least a portion of the solid source and provide the macroscopic zeolitic material,
wherein the macroscopic zeolitic material has a particle size of greater than about 0.1 mm.

10. The method of claim 9, wherein the solid source of amorphous silica alumina is contacted with an aqueous solution of the SDA.

11. The method of claim 10, wherein the SDA comprises an organic cation selected from the group consisting of a quaternary organoammonium ion, a diquaternary organoammonium ion, and a quaternized alkanolammonium ion.

12. The method of claim 11, wherein the amorphous silica alumina and the SDA are further contacted with a crystallization inducing templating agent comprising (i) a second organic cation that is different from the organic cation of the SDA, (ii) a metal cation, or (iii) a mixture of (i) and (ii), to crystallize the zeolite.

13. The method of claim 12, wherein the second organic cation is selected from the group consisting of a quaternary organoammonium ion, a diquaternary organoammonium ion, a quaternized alkanolammonium ion, a protonated amine, and a protonated alkanolamine, and wherein the metal cation is selected from the group consisting of an alkali metal cation and an alkaline earth metal cation.

14. The method of claim 9, wherein the solid source of amorphous silica alumina is contacted with the SDA in a non-aqueous solvent.

15. The method of claim 14, wherein the non-aqueous solvent is a polyol.

16. The method of claim 9, wherein step (a) provides an SDA-impregnated amorphous silica alumina and wherein step (b) comprises contacting the SDA-impregnated amorphous silica alumina with steam to provide the macroscopic zeolitic material.

17. The method of claim 9, wherein the solid source of amorphous silica alumina is contacted with vapors of the SDA.

18. The method of claim 17, wherein the SDA is an amine, a diamine, or an alkanolamine.

19. The method of claim 9, wherein the zeolite forming conditions include a contacting temperature from about 20° C. (68° F.) to about 300° C. (572° F.) and a contacting time from about 5 hours to about 15 days.

20. The method of claim 9, wherein the solid source of amorphous silica alumina is calcined, oil dropped sphere.
